(19) United States
(12) Patent Application Publication
(10) Pub. No.: US 2009/0278940 A1
(43) Pub. Date: Nov. 12, 2009

(54) Method of Testing a Display and Related Apparatus

(76) Inventors: Hsin-Ming Lin, Taipei Hsien (TW); Ping-Hung Chen, Taipei Hsien (TW); Yu-Lang Yang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/249,955

(22) Filed: Oct. 12, 2008

(30) Foreign Application Priority Data
May 9, 2008 (TW) 097117079

(51) Int. Cl. H04N 17/02

(52) U.S. Cl. 348/189; 348/E17.004

(57) ABSTRACT

A method of testing a display is provided to save test time and cost. The method includes providing a system command set corresponding to the display and a flow control command set to select, generating a testing software application including an executing sequence according to the selected system command set, the selected flow control command set and at least a test pattern, and then executing the testing software application to generate commands corresponding to the executing sequence for the display for testing.

### BACKGROUND OF THE INVENTION

1. Field of the Invention

The present invention relates to a testing method and related apparatus, and more particularly to an automated testing method and related apparatus for a display.

2. Description of the Prior Art

A display after design and manufacture stages needs to be processed with a product testing to test whether screen display and functions of the display are normal. Test factory generally provides a control station and a plurality of testing stations responsible for testing tasks related to different display functions or types for the display. In display testing process, an operator needs to follow particular steps and manually operate a remote control to control the testing stations and the display. For example, in each testing station, the operator needs to select a testing pattern for the display, and adjusts a display time and a position of the testing pattern one by one. In addition, the operator needs to control the display to go through the different testing station with the remote control. However, such a testing method costs more human resources and time, and thereby reduces the production rate.

### SUMMARY OF THE INVENTION

Therefore, the present invention provides a method and related apparatus for automation of testing a display to lower the manufacture cost.

The present invention discloses a method of testing a display including providing a system command set and a flow control command set to be selected for testing the display, generating a testing software application having an executing sequence according to a system command subset selected from the system command set, a flow control command subset selected from the flow control command set and at least a testing pattern, and then executing the testing software application to generate commands corresponding to the executing sequence for executing testing tasks for the display.

The present invention further discloses a testing device for testing a display, and the testing device includes a first transmission port, a memory unit, a user interface, a testing software application generating device, and a flow executing unit. The first transmission port is coupled to the display, and used for obtaining a system command set corresponding to the display. The memory unit is used for storing a flow control command set. The user interface is used for providing a user with the system command set obtained from the first transmission port and the flow control command set stored in the memory unit to select a system command subset and a flow control command subset. The testing software application generating device is used for generating a testing software application having an executing sequence according to the system command subset, the flow control command subset, and at least a testing pattern. The flow executing unit is coupled to the display, and used for executing the testing software application to generate commands corresponding to the executing sequence for executing testing tasks for the display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart of a testing process according to an embodiment of the present invention.

FIG. 2 is a structure diagram of a testing platform according to an embodiment of the present invention.

FIG. 3 is a functional block diagram of a testing device according to the FIG. 2.

### DETAILED DESCRIPTION

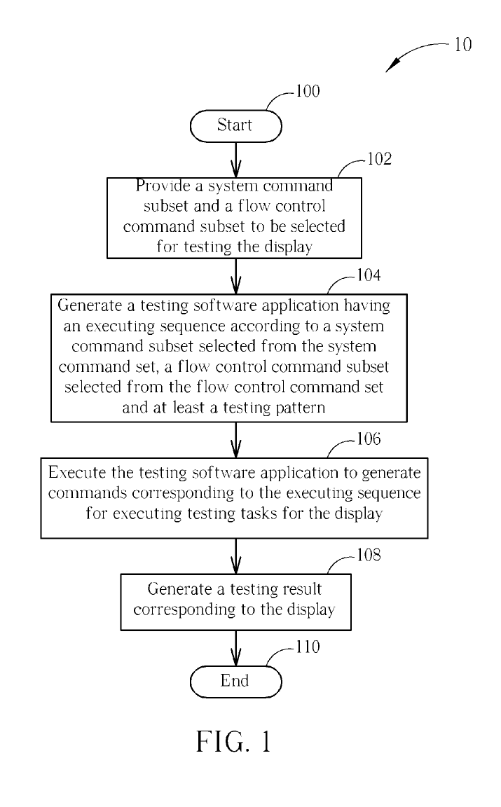

Please refer to FIG. 1, which is a flow chart of a process 10 according to an embodiment of the present invention. The process 10 is used for testing a screen displaying condition of a display, and includes the steps:

Step 100: Start.

Step 102: Provide a system command subset and a flow control command subset to be selected for testing the display.

Step 104: Generate a testing software application having an executing sequence according to a system command subset selected from the system command set, a flow control command subset selected from the flow control command set and at least a testing pattern.

Step 106: Execute the testing software application to generate commands corresponding to the executing sequence for executing testing tasks for the display.

Step 108: Generate a testing result corresponding to the display.

Step 110: End.

According to the process 10, the embodiment of the present invention obtains the system command set and flow control command set, and then selects the commands required for testing software application. The system command set includes a serial number of the display and information of a firmware version of the display. The flow control command set includes a pattern setting command, a time display command, a condition command (such as if else), a jump command (such as goto), a pause command (such as pause), a question switching command, a postpone command, a finish command, a testing station confirming command, etc. The pattern setting command is used for setting the testing pattern and display position thereof for the display. The time display command is used for controlling a display time length of the testing pattern for the display. The question switching command is used for setting a specific question to an operator, and according to the answer transferring to related steps (such as pause or jump). The finish command is used for indicating a testing end or interruption to jump out of a testing process corresponding execution of the testing tasks. Then, the testing software application is generated according to the system command subset, the flow control command subset and one or more testing patterns, and the executing sequence depends on the flow control command subset for determining the used testing pattern and the use sequence thereof, so as to determine the follow-up steps (such as jump, pause, or finish) and control the displaying of the testing pattern according to different states of the displaying of the testing patterns. The testing patterns include a black pattern, a white pattern, a grayscale pattern, a red pattern, a red-green-blue pattern, etc. Usually the testing pattern is selected from an external device. During execution of the testing software application, the commands corresponding to the executing sequence are generated to execute the testing tasks for display. Finally, according to whether the used testing pattern shown on display is qualified, a testing result corresponding to the display is generated. During the testing process, according to the testing process and the testing result, a corresponding voice signal is generated and played to notify an operator of the current testing progress and the testing state thereof.

In addition, when a testing platform provides the display with the testing stations with different of the testing patterns, a bar code corresponding to the testing station is scanned as the display passes through each of the testing stations. The testing station confirming command in the testing process is used for recording the testing state of the display in each of the testing stations.

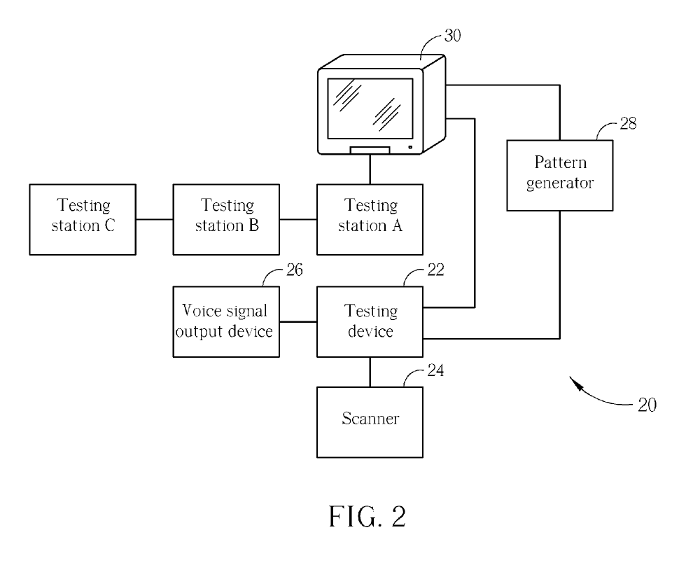

Please refer to FIG. 2, which is a structure diagram of a testing platform 20 according to an embodiment of the present invention. The testing platform 20 includes a testing device 22, a scanner 24, a voice signal output device 26, testing stations A, B, and C, a pattern generator 28, and a display 30. In the testing platform 20, the display 30 passes through the testing station A, B, and C in order, and the testing device 22 correspondingly controls the pattern generator 28 to generate a black pattern BPN, a white pattern WPN, and a red-blue-green pattern RGBPN to the display 30.

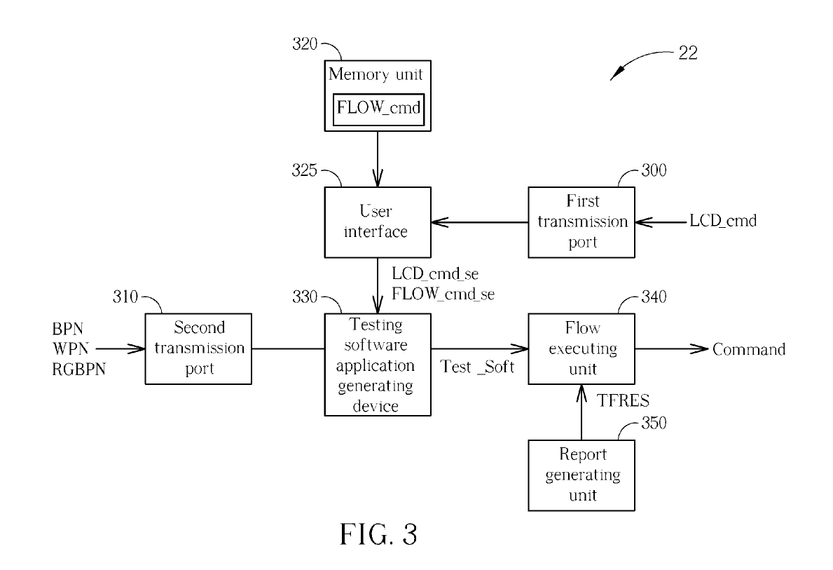

Please refer to FIG. 3, which is a functional block diagram of the testing device 22 according to FIG. 2. The testing device 22 includes a first transmission port 300, a second transmission port 310, a memory unit 320, a user interface 325, a testing software application generating device 330, a flow executing unit 340, and a report generating unit 350. The first transmission is coupled to the user interface 325 and communicates with the display 30 through an RS-232 transmission interface to obtain a system command set LCD_cmd including a serial number of the display 30 and information of a firmware version of the display 30. The second transmission port 310 is coupled to the testing software application generating device 330, and used for obtaining assign numbers of the black pattern, the white pattern, and the red-blue-green pattern from the pattern generator 28. The memory unit 320 is used for storing a flow control command set FLOW_cmd. The user interface 325 is used for an operator to select a system command subset LCD_cmd_se from the system command set LCD_cmd through the first transmission port 300, and a flow control command subset FLOW_cmd_se from the flow control command set Flow_cmd stored in the memory unit 320. The testing software application generating device 330 is used for generating a testing software application Test_Soft having an executing sequence according to the system command subset LCD_cmd_se, the flow control command subset FLOW_cmd_se, the black pattern BPM, the white pattern WON, and the red-blue-green pattern RGBPN. The executing sequence can be decided by an operator, and include a generating sequence of the abovementioned testing patterns, a testing sequence of the testing stations, a testing question, a testing result, etc.

The flow executing unit 340 communicates with the display 30 through the RS-232 transmission interface, and is used for executing the testing software application Test_Soft to generate and provide commands corresponding to the executing sequence of the testing software application Test_Soft for the display 30 for testing tasks. The commands for the display 30 include commands controlling the display to display the black pattern, the white pattern, and the red-blue-green pattern at the testing stations A, B, and C respectively. In addition, when the display 30 passes through the testing stations A, B and C, the flow executing unit 340 controls the scanner 24 to scan the bar codes corresponding to the testing stations A, B and C, and thereby records the corresponding testing results.

After display 30 finishes the testing process related to the testing stations A, B and C, the report generating unit 350 generates a testing result TFRES corresponding to display 30. The testing result TFRES records a qualified state of the testing pattern at each of the testing stations. In addition, the flow executing unit 340 generates and outputs corresponding voice signals to the voice signal output device 26 according to output commands and the testing result TFRES to notify an operator of a current testing progress and the testing state thereof.

In conclusion, the embodiments of the present invention provide an automated testing process according to characteristics of a display, and utilize voice signals to notify an operator of a testing progress. Therefore, the embodiments of the present invention simplify the testing process, and saving time and cost.

Those skilled in the art will readily observe that numerous modifications and alterations of the device and method may be made while retaining the teachings of the invention.

What is claimed is:

1. A method of testing a display, the method comprising:
providing a system command set and a flow control command set to be selected for testing the display;
generating a testing software application having an executing sequence according to a system command subset selected from the system command set, a flow control command subset selected from the flow control command set and at least a testing pattern; and
executing the testing software application to generate commands corresponding to the executing sequence for executing testing tasks.

2. The method of claim 1 further comprising providing a plurality of testing patterns for selection.

3. The method of claim 1 further comprising generating a testing result corresponding to the display.

4. The method of claim 1, wherein the system command set comprises a serial number of the display and information of a firmware version of the display.

5. The method of claim 1, wherein the flow control command set comprises a pattern setting command, a time display command, a condition command, a jump command, a pause command, a question switching command, a postpone command, a finish command, and a testing station confirming command.

6. The method of claim 3 further comprising generating and playing a corresponding voice signal according to the testing tasks and the testing result.

7. The method of claim 2, wherein the plurality of testing patterns comprise a black pattern, a white pattern, a grayscale pattern, a red pattern, and a red-green-blue pattern.

8. The method of claim 3 further comprising through the testing process controlling the display to pass through a plurality of testing stations corresponding to the plurality of testing patterns.

9. The method of claim 8 further comprising scanning bar codes corresponding to the plurality of testing stations.

10. A testing device for testing a display, the testing device comprising:
a first transmission port coupled to the display, for obtaining a system command set corresponding to the display;
a memory unit for storing a flow control command set;
a user interface for providing a user with the system command set obtained from the first transmission port and the flow control command set stored in the memory unit to select a system command subset from the system command set and a flow control command subset from the flow control command set;
a testing software application generating device for generating a testing software application having an executing sequence according to the system command subset, the flow control command subset, and at least a testing pattern; and
a flow executing unit coupled to the display, for executing the testing software application to generate commands corresponding to the executing sequence for executing testing tasks for the display.

11. The testing device of claim 10 further comprising a second transmission port for obtaining the at least a testing pattern from a pattern generator.

12. The testing device of claim 10, wherein the system command set comprises a serial number of the display and information of a firmware version of the display.

13. The testing device of claim 10, wherein the flow control command set comprises a pattern setting command, a time display command, a condition command, a jump command, a pause command, a question switching command, a postpone command, a finish command, and a testing station confirming command.

14. The testing device of claim 10, wherein the flow executing unit generates and plays a corresponding voice signal according to the testing tasks and a testing result.

15. The testing device of claim 11, wherein the at least a testing pattern comprises a black pattern, a white pattern, a grayscale pattern, a red pattern, and a red-green-blue pattern.

16. The testing device of claim 10, wherein the testing software application through the testing process controls the display to pass through the plurality of testing stations corresponding to the at least a testing pattern.

17. The testing device of claim 13, wherein the flow executing unit is coupled to a scanner, and controls the scanner to scan bar codes corresponding to the plurality of testing stations.

18. The testing device of claim 10, wherein the first transmission port and the flow executing unit communicate with display through an RS-232 transmission interface.

19. The testing device of claim 10 further comprising a report generating unit coupled to the flow executing unit, for generating a testing result corresponding to the display.
